(19) United States
(12) Patent Application Publication
(10) Pub. No.: US 2018/0058583 A1
(43) Pub. Date: Mar. 1, 2018

(54) SEAL

(71) Applicant: Rubberatkins Ltd., Aberdeen (GB)

(72) Inventors: Nicholas Atkins, Banchory (GB); Vijay Avanashiappan, Aberdeen (GB); Craig Spalding, Aberdeenshire (GB); Krishna Kankanalapalli, Aberdeen (GB)

(21) Appl. No.: 15/683,866

(22) Filed: Aug. 23, 2017

(30) Foreign Application Priority Data
Aug. 23, 2016 (GB) 1614388.5
Jun. 28, 2017 (GB) 1710352.4

(51) Int. Cl. F16J 15/10

(52) U.S. Cl. CPC F16J 15/104

(57) ABSTRACT

An annular seal (12) is operable to seal an annular gap (140) between a first member (120) and a second member (130). The seal (12) is configured to be received in a recess (20) in the first member (120) and to close/seal the annular gap (140). The seal (12) comprises a substantially solid body (13) comprising a first surface (24), which in use abuts the recess (20) in the first member (120) and a second surface (26), which in use faces/abuts the second member (130). The first surface (24) comprises, a width wise concave section (32) across at least part of the width of the seal (12).

### FIELD

The present invention relates to an annular pressure seal operable to provide efficient sealing between a mandrel and a casing in a downhole application. In particular, the present invention relates to an unbonded seal operable to efficiently seal a gap defined between two concentrically arranged members.

### BACKGROUND

Seals work by creating positive pressure against a surface thereby preventing leaks. The relationship between two surfaces defining a gap to be sealed determines, what type of seal to use. The interaction of the two surfaces can be classed as either static or dynamic.

Static seals are typically used when there is no relative motion between mating surfaces, for example a mandrel in a housing, which once assembled the relative position of the mandrel and the casing/housing is fixed.

Dynamic seals are typically used when there is relative motion between the mating surfaces, for example axial, reciprocating, rotational etc.

Seals that can seal annular gaps, which may be subject to pressure loading, are typically set in a groove provided on the surface of one member, for example a mandrel and the seal is operable to seal an annular gap defined between a first member and a second member, for example a mandrel and a housing respectively. Seals of this type typically come in two types; namely bonded and unbonded.

Bonded seals, as the name suggests, are bonded/adhered to a surface of a groove or recess in, for example a mandrel. A bonded seal is not known to bridge large extrusion gaps. Also, the nature of the bonded seal exhibits little versatility and makes for time-consuming, therefore expensive, fitting and manufacture. Moreover, once damaged replacement of the bonded seal can also be time consuming and expensive.

Unbonded seals are typically more versatile than bonded seals and are therefore more expeditious and hence less expensive to fit. However, unbonded seals are known to have limited capacity to efficiently fill/bridge the gap they are intended to seal.

A known, unbonded seal as illustrated in FIG. 1 comprises an inverted T-shaped rubber body comprising a vertical portion, the top of which forms a contact seal with the outer member and a horizontal portion which is received in a groove defined on the surface of the inner member to prevent expulsion of the seal when the inner member is being run in and when it is located within the outer member.

An annular gap is defined between the inner and outer member and the function of the seal is to seal the annular gap. In the illustrated example two coil springs are embedded in the rubber block. When pressure is applied the springs expand and restricts extrusion of the rubber into the gap opposite the source of pressure. Such seals are prone to leakage.

Gland seals are another example of an unbonded seal.

The unbonded seal described above are typically used in static applications because in dynamic applications, for example where the seal passes over ports, the use of such seals is not generally recommended because nibbling, jumping out, premature wear and seal failure is often the result.

Accordingly, an improved unbonded seal is desirable.

### SUMMARY

A first aspect of the present invention provides an annular seal operable to be received in a recess in a first member and to seal an annular gap between the first member and a second member, wherein the first and second member are arranged relative to each other to define the annular gap between them, the seal comprises:

a substantially solid body comprising a first surface, which in use abuts the recess in the first member and a second surface, which in use faces the second member, wherein the first surface comprises, a width wise concave section across at least part of the width of the seal.

Before assembling the first member and second members, the seal is received in the recess in the first member and the concave section of the seal is oriented towards a base of the recess provided in the first member, for example a mandrel, and the opposite surface of the seal is oriented towards the second member, for example a casing in which the mandrel is inserted.

Upon insertion of the first member (mandrel) into the second member (casing) the seal is effectively sandwiched between the base of the recess of the first member (mandrel) and the inner wall of the second member (casing), the seal sealing outwardly against the inner wall of the second member (casing). By way of further example, the first member and the second member may be provided by, for example a rod and piston arrangement.

In an alternative embodiment, the first member may be a casing and the second member may be a mandrel, which is inserted into the casing. In such an embodiment, the recess would be on an inner wall of the casing and seal inwardly against the mandrel.

During assembly of the first and second member, the concave section allows for easier insertion of the first member into the second member compared with known seal configurations, because the concave section imparts resilience/give to the body of the seal thereby allowing deflection of the body, in particular deflection of the second surface towards the first surface due to an interference fit between the second member and the seal. Once the assembly of the first and second member is complete an interference/sealing fit between the second member and the seal is restored/established and maintained due to the resilience of the body of the seal and the elastic nature of righting the concave section to ensure that in an unpressurised state sealing contact is maintained between the second surface and the second member and the first surface and the first member following complete insertion of the first member into the second member.

The body may comprise a cross sectional shape which is substantially trapezoidal, wherein the body comprises:

a base edge and a top edge arranged substantially parallel and two side edges, each side edge extending up from the base edge at an acute angle and each side edge forming a vertex with the base edge, wherein the concave section is defined between the vertices on the base edge.

The trapezoidal form comprises a tapered outer surface which coupled with the resilience provided by the concave section may reduce or prevent damage to the seal during initial insertion of the first member into the second member.

In a dynamic application, for example reciprocating movement of one or more of the first and second members, the tapered outer surface coupled with the resilience provided by the concave section may reduce the occurrence of a seal jumping out of the recess when passing over ports in a reciprocating application and may also reduce the occurrence of seal failure due to nibbling and premature wear. In the unloading situation a seal on a piston rod will pass into a larger ID casing with vent ports which will allow the pressure trapped behind the seal to escape quickly.

The trapezoidal form of the body and the concave section of the base edge imparts resilience, which allows the body to compress and deflect in response to the seal and first member being pushed into the second member against an interference fit, thereby facilitating insertion of the first member and the seal with minimal or no damage to the seal.

The body may further comprise a convex protrusion extending from each side edge proximate each vertex. When subject to pressure, a first, leading, protrusion will be displaced into contact with the annular gap, thereby ensuring that the seal is operable to seal the gap. A second, trailing, protrusion is operable to limit the displacement of the leading protrusion such that the seal is prevented from being displaced from the recess and extruding into the gap.

During compression of the body, each vertex may be pressed into a corner of a recess, the corner being defined by the base of the recess and the sidewall of the recess.

Each vertex may provide a pivot point about which the seal body pivots whilst the seal body is being displaced during assembly of the first and second members and during pressurisation of the annular gap defined between the first and second members.

The seal body the pivot most easily may pivot about the vertex when the vertex is engaged, in use, with a recess corner. Each protrusion may include a resilient member embedded within the body and proximate each vertex. The resilient member may be of the same or a different material than the body.

The resilient member may comprise a spring, for example a helical spring. The helical spring may comprise substantially open coils, wherein a space is defined between each turn of the spring, such that when embedded within the seal body, the material forming the body of the seal occupies the space between each turn.

An embedded open coil spring facilitates improved deformation of the seal body and improved sealing between the seal body and the annular gap compared with prior art seals because as the seal body deforms the spring expands due to pressure changes within the annular gap effecting deformation of the seal body and the material occupying the spaces between coils facilitates local displacement of the seal body. Each coil of the spring moves independently thereby controlling deformation of the seal body and ensuring resilience of the seal body such that the conformation of the seal body is maintained whether subject to pressure loading or not.

Alternatively, the resilient member may comprise a gland seal. The gland seal may be kidney shaped.

The resilience of the resilient member helps maintain an interference fit between the seal body and the second member and also helps control deformation of the seal body during assembly of the first member and second member, during pressurisation, in a dynamic situation and in an unloading situation.

The concave part of the base edge may comprise two angle edges extending up from the base edge and an upper edge, wherein the upper edge is substantially horizontal and wherein the upper edge is arranged to bridge upper ends of each angled edge. Alternatively, the concave part of the base edge may be curved.

The seal may be made from elastomeric material. The seal may be moulded. Alternatively, the seal may be extruded.

In one embodiment, the seal according to the first aspect of the present invention is intended for use in high temperature, high pressure environments, which are very harsh and in which it is known that existing seals, whether bonded or unbonded, are prone to seal failure and/or leakage due to insufficient contact between the seal body and the inner surface of the second member.

In one embodiment, a seal according to the first aspect of the present invention provides a seal capable of concealing large extrusion gaps and capable of holding high pressures for a range of temperatures, high and low.

In one embodiment, a seal according to a first aspect of the invention provides an unbonded seal, which performs in a manner generally associated with bonded seals, but does not incur the same expense, does not incur the same time consuming installation and does not incur the same limitations imposed on the designs of a bonded seal. Therefore, whilst some known bonded seals can bridge large extrusion gaps, they are not particularly desirable due to the expense and limitations associated with bonded seals.

A seal according to the first aspect of the present invention provides an improved unbonded seal for use in static, dynamic and dynamic unloading situations.

### BRIEF DESCRIPTION OF THE DRAWINGS

Embodiments of the present invention will now be described with reference to the accompanying drawings in which:

FIG. 1 illustrates a schematic representation of a prior art seal;

FIG. 2 illustrates an example of a mandrel and casing assembly comprising an unloaded seal according to an embodiment of the present invention;

FIG. 2a illustrates an enlarged view of the unloaded seal of FIG. 2.

FIG. 2b illustrates an enlarged view of the seal of FIG. 2 in a substantially loaded state, which is representative of an unpressurised annular gap.

FIG. 2c illustrates an enlarged view of the seal of FIG. 2 subject to annulus pressure in the annular gap between a mandrel and a casing; and

FIG. 3 illustrates a schematic representation of a seal according to an embodiment of the present invention.

### DESCRIPTION

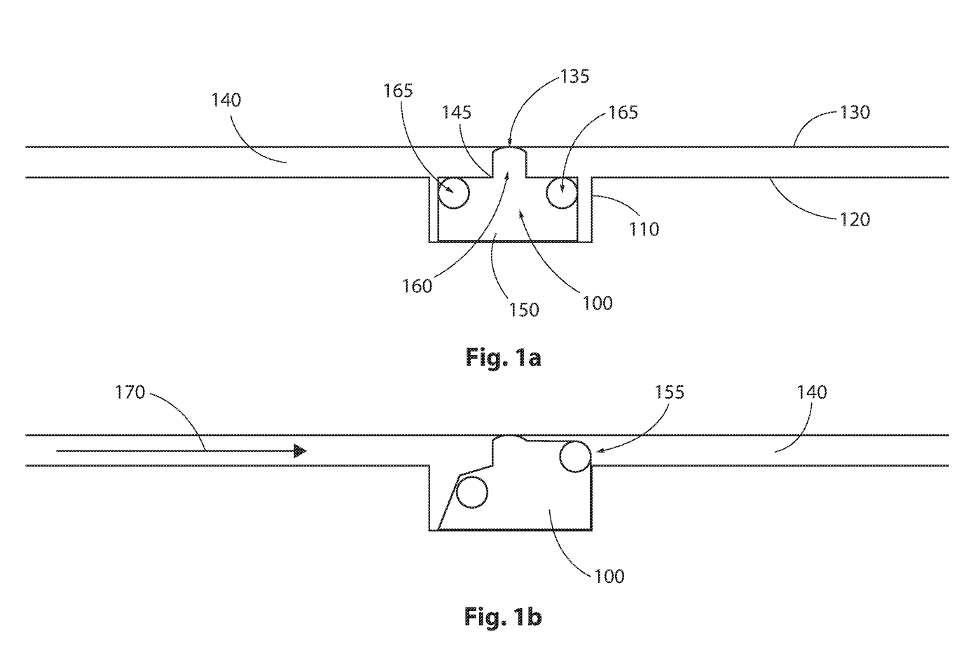

FIG. 1 illustrates a prior art seal 100 located within an annular groove 110 provided in a mandrel 120, which is inserted into a casing 130. The seal 100 is operable to close an annular or extrusion gap 140 between the outer surface of the mandrel 120 and the inner surface of the casing 130.

The prior art seal 100 includes a rubber body 150 having a T-shape and being arranged with the end of the vertical portion 160 touching the inner surface 135 of the casing 130 during insertion of the mandrel 120 into the casing 130. Engagement between the vertical portion 160 and the inner surface 135 of the casing 130 defines the engaging sealing surface when the annular gap 140 is not pressurised.

Two closed coil springs 165 are provided at the ends of the horizontal portion 150. The springs 165 are operable to control deformation of the seal 100 when the seal is subject to pressure 170 (see lower example in FIG. 1) from the annular gap 140; the annular gap 140 is defined by a space between the mandrel 120 and the casing 130.

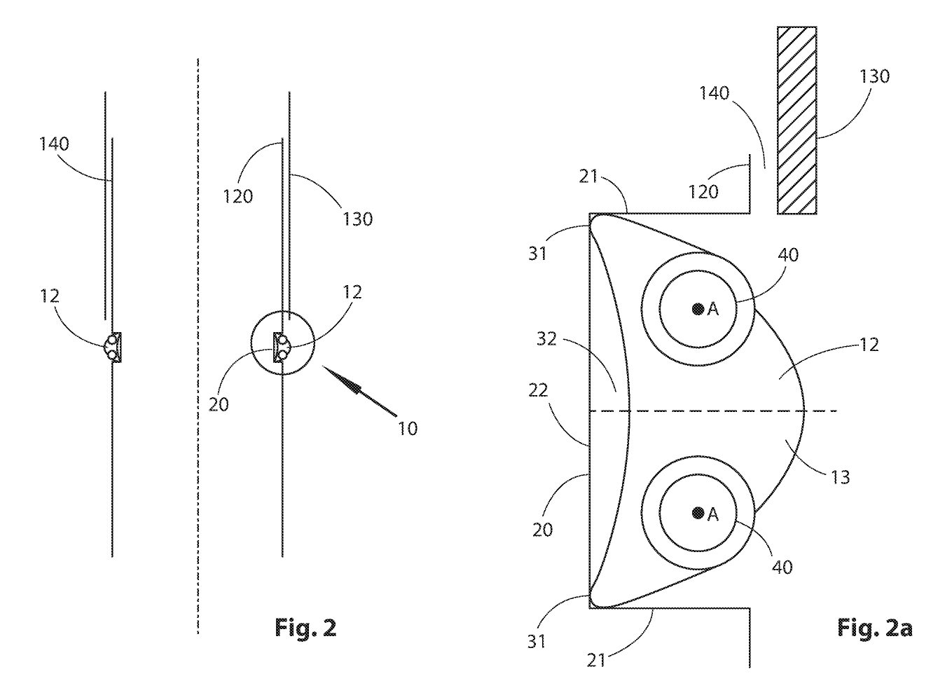

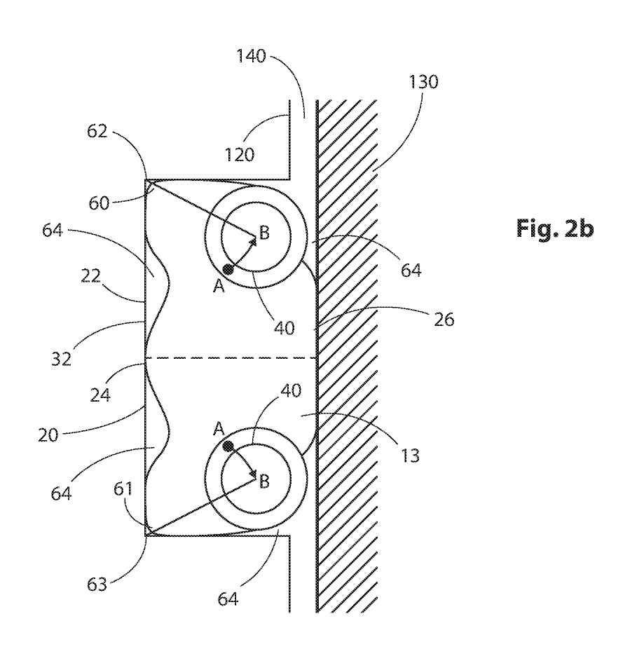

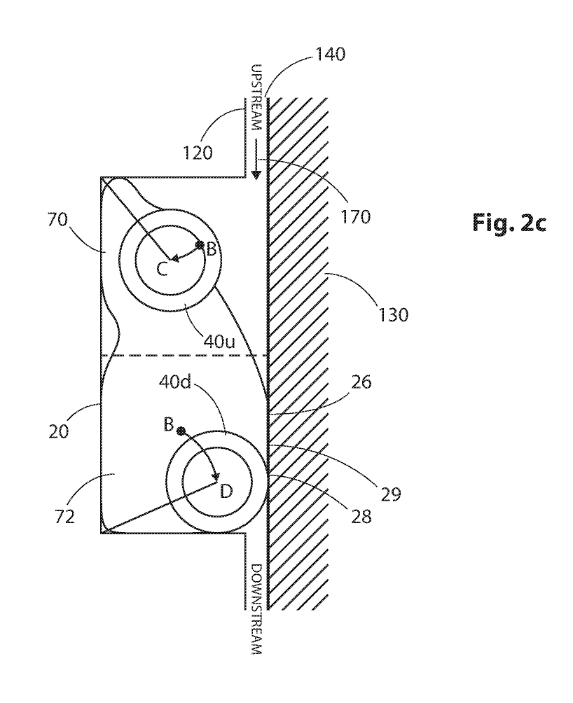

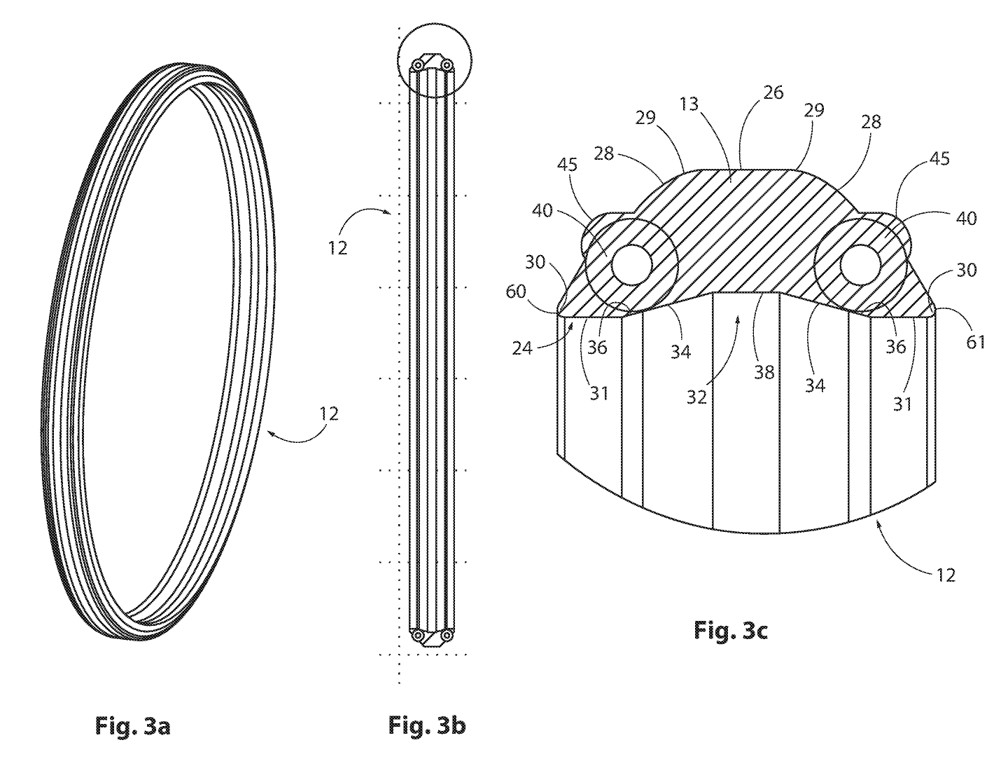

Due to the interference fit provided between the vertical portion 160 of the seal 100 and the casing 130 and the stress concentration areas 145 defined between the horizontal portion 150 and the vertical portion 160 the seal 100 of the configuration illustrated in FIG. 1 is susceptible to damage during assembly of the mandrel 120 into the casing 130. Such damage can affect the sealing properties of the seal 100 when it is subjected to pressure 170. In addition, deformation of the leading side 155 of the seal is unlikely to deform fully because of the change in geometry from the horizontal portion 150 to the vertical portion 160. Therefore, it is highly likely that the sealing contact between the vertical portion 150 and the casing wall 130 may be breached and therefore leakage is likely to be the result. A seal 100 as illustrated in FIG. 1 lacks the resilience of a seal 12 described below with reference to FIGS. 2 and 3.

FIGS. 2, 2a,2b and 2c illustrate a similar arrangement to that of FIG. 1, where the first and second members are provided by a mandrel 120 and a casing 130 arranged such that an annular gap 140 is defined between the mandrel 120 and the casing 130. A seal 12 is seated within an annular groove 20. A more detailed view of the seal 12 is illustrated in FIG. 3 as described below.

FIG. 2 illustrates the seal 12 seated within the annular groove 20.

FIG. 2a illustrates an enlarged view of the seal 12 of FIG. 2.

FIG. 2b illustrates an enlarged view of the seal 12 of FIG. 2 in a substantially undeformed state, which is representative of an unpressurised annular gap 140.

FIG. 2c illustrates an enlarged view of the seal 12 of FIG. 2 in a deformed state where the annular gap 140 is subject to pressure 170.

A seal 12 according to an embodiment of the present invention reveals more uniform deformation than the prior art seal 100 illustrated in FIG. 1. This is discussed further below following a more detailed description of the configuration of the seal 12 as illustrated in FIG. 3.

FIG. 3 illustrates a perspective view of an annular seal 12 according to an embodiment of the present invention. FIG. 3 also illustrates a cross-sectional view of the seal 12 such that the shape and form of the seal 12 can be visualised more clearly.

In the illustrated example, the seal 12 is formed of rubber and includes a substantially trapezoidal form. In the illustrated example, the cross-sectional shape of the seal 12 is substantially an isosceles trapezoid, which includes a base edge 24, a top edge 26 and two inclined side edges 28. The base edge 24 and the top edge 26 are substantially parallel. The two inclined side edges 28 meet the base edge 24 at a first corner 60 and a second corner 61.

The side edges 28 each form an acute angle 30 with the base edge 24 and an obtuse angle with the top edge 26. In the illustrated example, the edge 29 defined by the junction of the side edge 28 and the top edge 26 is curved. This ensures uniform contact between the seal surfaces 26, 28, 29, the mandrel 120 and the casing 130 surfaces when the seal 12 is deformed due to pressure loading 170 in the annular gap 140 as illustrated in figure c

In the illustrated example, the base edge 24 is formed substantially of three sections; namely, two horizontal portions 31 and a recessed section 32.

A horizontal portion 31 is provided on each side of the recessed section 32. In the illustrated example of deployment of the seal 12, each horizontal portion 31 defines a mandrel engaging surface such that the seal 12 engages soundly with the base of the groove 20.

The top edge 26 defines the casing engaging surface.

In the illustrated example, the recessed section 32 includes two inclined side edges 34 and a substantially horizontal upper edge 38. The inclined side edges 34 each extend up at an obtuse angle 36 from each of the horizontal sections 31. The inclined side edges 34 each terminate at the ends of the substantially horizontal upper edge 38 to define the recessed section 32. Alternatively, the recessed section may be a continuous curve, which extends between the ends of the horizontal portions 31.

The seal 12 includes embedded springs 40. More specifically, in the illustrated example the springs 40 are open coiled springs, i.e. there is a distinct space between each turn of the spring 40. The open form of the spring 40 means that when the seal 12 is moulded the spring 40 will be embedded into the body of the seal 12 and the seal material will occupy the space between each turn. As such, when the seal 12 deforms due to pressure load (as will be discussed in connection with FIG. 2c) an efficient seal is formed due to the spring 40 energising the seal 12 such that the spring 40 and the seal body 13 deform as a unit and in a controlled manner.

A protrusion 45, coincident with the location of the spring 40 is defined on each of the angled edges 28. With reference to FIG. 2c, the protrusion 45 on the leading side of the seal 12 serves to seal across the annular gap 140 in the event pressure 170 is applied.

The springs 40 provide a constant force and therefore the spring 40 on the trailing edge controls the movement of the seal body within the cavity provided by the groove 20 and the annular gap 140. The springs 40 act together with the resilience of the seal body 13 to prevent the seal body 13 on the leading side from extruding into the annular gap 140. The resilience of the springs 40, the seal body 13 and the resilience provided by the shape of the recessed section 32 ensure that when pressure is removed the seal 12 shape and form returns to a substantially undeformed form as illustrated in FIGS. 2a and 3.

The springs 40 may also increase temperature capability of the seal 12, which is particularly useful in an application where the seal is subject to elevated temperatures.

By embedding the springs 40 in the body of the seal 12 the risk of damage to the springs 40 during insertion of the mandrel 120 into the casing 130 is minimised. In addition, as discussed above, the springs 40 are open coil springs, which means that the seal material, for example rubber, can flow between the turns of the spring 12 during manufacture.

Referring to FIG. 2a, the centre of the springs 40 are indicated by the letter “A”. The seal 12 may be oriented such that the seal body 13 is received within a groove 20 defined on a mandrel surface 120 such that the horizontal base portions 31 rest against the base 22 of the groove 20 and the recess section 32 faces the base 22 of the groove 20. The horizontal portions 31 each provide a mandrel engaging surface as discussed above. Although shown as engaging the sidewalls 21 of the groove 20, the seal 12, in other embodiments, can be spaced away from one or both of the sidewalls 21.

Referring to FIG. 2b, whilst inserting the mandrel 120 and seal 12 into the casing 130 the recess section 32 imparts resilience to the seal body 13, such that the seal body 13 deforms when the top edge 26 is squeezed into the casing 130. This deformation causes the seal 12 to deflect downwardly effectively reducing the volume defined by the recess portion 32 which effectively flattens towards the surface of the groove 20 thus making insertion of the mandrel 120 into the casing 130 easier and less prone to seal damage.

The deflection of the seal 12 pushes the seal bottom corners 60,61 to press into a first and second groove corner 62,63 respectively. This loading causes the springs 40 to pivot outwards in the direction of arrow, the centre of the springs pivoting outwards from position “A” on FIG. 2a to position “B” shown in FIG. 2b. In this position, the movement of the springs 40 has effectively reduced the annular or extrusion gap 140. It also be noted that the base edge 24 has engaged with the groove base 22. It will be noted that, even in this position, there is free space 64 around and under the seal 12

When the mandrel 120 is fully inserted within the casing 130, the elastic properties of the seal 12 means that it will push back against the casing 130, thereby effectively pushing the top edge 26 into contact with the casing 130 thereby creating sealing engagement between the seal body 13, the mandrel 120 and the casing 130.

An example will now be described where the seal 12 is subject to a pressure 170 from an upstream side (indicated by “upstream”) on FIG. 2c. For the purposes of this example, the seal 12 will be described as two halves, the side closer to the pressure being the upstream side 70 and the side further from the pressure being the downstream side 72. When the assembly is subject to pressure 170, as illustrated in FIG. 2c the combination of the resilience and strength of the springs 40, the configuration of the recessed section 32 and the trapezoidal form of the seal body 13 permits the seal 12 to deform within the groove 20 whilst maintaining substantially constant surface pressure between the uppermost surfaces 26, 29, 28, 45 of the seal 12, the annular gap 140 and the casing 130. When the seal 12 is subjected to pressure 170 the upstream side 70 of the seal 12 is pushed down, the pressure facing spring 40u rotating about the seal bottom corners 60 the centre of the spring moving from position “B” to position “C”, although not visible on FIG. 2C, position “C” is below figure “A”, its natural relaxed position as shown in FIG. 2A. This creates compression in the seal 12 and increases the overall free space above the pressure facing or upstream spring 40u.

The seal 12 will moves across the groove 20 reducing all free space on the opposite side, or downstream side 72, from the applied pressure 170. This change in free space energises up the downstream side 72, the pressure holding side, of the seal 12. This creates rotation in the downstream side spring 40d, moving the centre of the spring from position “B” to position “D”, pushing the spring 40d up into the side wall and the annular gap 140. When the spring 40d is in this position the elastomer has a 360° radial mechanical support preventing pressure related extrusion into the annular gap 140.

A further advantage of this seal design, is that if the mandrel 120 is pushed out of the casing 130 whilst still under pressure. The spring 40u closest to the pressure side acts as an anchor as the pressure in this area is forcing the spring 40 downwards on the base of the groove 20.

The shape and form of the seal 12 according to embodiments of the present invention provides a functionally improved and more versatile seal than present seals. As described above the seal 12 is versatile because a seal of the shape and form described can be deployed in static and dynamic environments and is effective in an unloading environment without risk of being expelled from the groove 20, where for example the seal 12 may pass into a larger OD when it unloads. The larger OD may have ports in this section to allow the pressure to escape outside the tool.

An example of a static environment may be a harsh well environment with high pressures and high temperatures. High pressures and high temperatures have become increasingly challenging within the oil and gas industry and therefore presents a problem that needs to be addressed. The seal 12 according to embodiments of the present invention provides an efficient seal that can be deployed in such harsh environments and which is effective in sealing large extrusion gaps, for example gaps of up to 0.4 mm (0.015 inches) and is capable of withstanding high pressure applications, for example pressures in the region of 1024 Bar (15000 psi).

The seal 12 as illustrated in FIG. 3 can also perform efficiently in dynamic pressure environments and in both low and high temperatures, for example from 25 degrees Celsius (77 degrees Fahrenheit) to 343 degrees Celsius (650 degrees Fahrenheit).

In a dynamic situation, for example a rod and piston application, the seal 12 can perform efficiently when the piston is moved under pressure from the original casing/housing internal diameter to a larger internal diameter so the sealing capacity is lost and pressure escapes. The larger diameter may be so large it represents a port to the outside of the tool. This arrangement may generate a rush of pressure across the sealing face which would tend to draw the seal out of the groove 20. However, the shape and form of the seal 12 is such that the seal 12 defeats the pull of the pressure across the sealing face and therefore remains in the groove 20. As such the seal 12 could be used again when the piston is moved into the smaller diameter again.

It will be appreciated that a seal 12 according to an embodiment of the present invention simplifies and expedites insertion of a mandrel 120 into a casing 130 because during insertion the recessed section 32 allows the seal body 13 to deform such that the surfaces 34 and 38 of the recessed section 32 move towards the base of the groove 20 and thereby create a slightly relaxed interference fit between the top edge 26 of the seal 12 and the casing inner surface. This configuration of seal 12 also reduces the occurrence of damage to the seal 12 during insertion into the casing 130.

When the insertion of the mandrel 120 into the casing 130 is complete, as described above the resilience and bias of the seal material and shape will allow the seal to restore to its natural shape such that the top edge 26 (casing engaging surface) creates a compression force against the casing wall to maximise the sealing properties provided by the seal 12.

The springs 40 are substantially contained within the body of the seal. There is a slight protrusion 45 which adds to the interference fit of the seal within the annular gap 40.

The trapezoidal form of the seal 12 means that the entire external surface of the seal 12 can deform to mould to the gap 140 being closed.

Whilst a specific embodiment of the present invention has been described above, it will be appreciated that departures from the described embodiment may still fall within the scope of the present invention.

1. An annular seal operable to be received in a recess in a first member and to seal an annular gap between the first member and a second member, wherein the first and second member are arranged relative to each other to define the annular gap between them, the seal comprises:
a substantially solid body comprising a first surface, which in use abuts the recess in the first member and a second surface, which in use faces the second member, wherein the first surface comprises, a width wise concave section across at least part of the width of the seal.

2. A seal as claimed in claim 1, wherein the body comprises a cross sectional shape which is substantially trapezoidal, wherein the body comprises:
a base edge and a top edge arranged substantially parallel and two side edges, each side edge extending up from the base edge at an acute angle and each side edge forming a vertex with the base edge, wherein the concave section is defined between the vertices on the base edge.

3. A seal as claimed in claim 2, wherein during compression of the body, each vertex may be pressed into a corner of a recess, the corner being defined by the base of the recess and the sidewall of the recess.

4. A seal as claimed in claim 2, wherein each vertex provides a pivot point about which the seal body pivots allowing deformation of the seal body during assembly of the first and second members and/or during pressurisation of the annular gap defined between the first and second members.

5. A seal as claimed in claim 4, wherein the seal body is configured to pivot about the vertex when the vertex is engaged, in use, with a corner of a recess, the corner being defined by the base of the recess and the sidewall of the recess.

6. A seal as claimed in claim 2, wherein the body further comprises a convex protrusion extending from each side edge proximate each vertex.

7. A seal as claimed in claim 6, wherein each protrusion includes a resilient member embedded within the body and proximate each vertex.

8. A seal as claimed in claim 7, wherein the resilient member is of a different material than the body.

9. A seal as claimed in claim 7, wherein the resilient member comprises a spring.

10. A seal as claimed in claim 9, comprising a helical spring.

11. A seal as claimed in claim 10, wherein the helical spring comprises substantially open coils, wherein a space is defined between each turn of the spring, such that when embedded within the seal body, the material forming the body of the seal occupies the space between each turn.

12. A seal as claimed in claim 7, wherein the resilient member comprises a gland seal.

13. A seal as claimed in claim 12, wherein the gland seal is kidney shaped.

14. A seal as claimed in claim 1, wherein the concave part of the base edge comprises two angle edges extending up from the base edge and an upper edge, wherein the upper edge is substantially horizontal and wherein the upper edge is arranged to bridge upper ends of each angled edge.

15. A seal as claimed in claim 1, wherein the concave part of the base edge is curved.

16. A seal as claimed in claim 1, wherein the seal body is made from elastomeric material.
